(19) United States
(12) Patent Application Publication
(10) Pub. No.: US 2006/0147614 A1
(43) Pub. Date: Jul. 6, 2006

(54) Transferable antireflection material for use on optical display

(75) Inventor: Kazuhiko Mizuno, Tokyo (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/027,655

(22) Filed: Dec. 30, 2004

(51) Int. Cl. B05D 5/12; B05D 5/06

(52) U.S. Cl. 427/66; 427/162

(57) ABSTRACT

An optical display, and method for forming an optical display, having improved antireflection properties and durability is formed by applying a transferable antireflection material to an optical substrate through the use of an in-mold or heat press technique or alternatively by an ultraviolet exposure technique. The transferable antireflection material is formed prior to application to the substrate and has at least a low refractive index layer and a high refractive index layer coupled to a release film. The low index reflection layer is preferably a silicone-modified fluoropolymer material having good durability, low refractivity, and appropriate adhesion to the release layer and subsequently applied high index refraction layer. The optical display is then coupled to a housing of an article for use.

### TECHNICAL FIELD AND INDUSTRIAL APPLICABILITY OF THE INVENTION

The present invention relates to antireflection materials and more specifically to transferable antireflection materials for optical goods.

### BACKGROUND OF THE INVENTION

Antireflective polymer films (“AR films”), or AR coatings, are becoming increasingly important in the display industry. New applications are being developed for low reflective films and other AR coatings that are applied to optical substrates of articles used in the computer, television, appliance, mobile phone, aerospace and automotive industries.

AR films are typically constructed by alternating high and low refractive index polymer layers in order to minimize the amount of light that is reflected. Desirable features in AR films for use on the substrate of the articles are the combination of a low percentage of reflected light (e.g. 1.5% or lower) and durability to scratches and abrasions. These features are obtained in AR constructions by maximizing the delta RI between the polymer layers while maintaining strong adhesion between the polymer layers.

AR films are traditionally formed by applying the low and high refractive index polymer layers directly to an optical substrate. However, the AR films may alternatively be first formed on a release layer as part of a transferable film. The fully formed transferable film is then applied to the optical substrate, and the release layer removed, to form the optical display.

It is well known that the low refractive index polymer layers used in AR films are usually derived from fluorine containing polymers (“fluoropolymers” or “fluorinated polymers”), which have refractive indices that range from about 1.3 to 1.4. Fluoropolymers provide unique advantages over conventional hydrocarbon based materials in terms of high chemical inertness (in terms of acid and base resistance), dirt and stain resistance (due to low surface energy), low moisture absorption, and resistance to weather and solar conditions.

The refractive index of fluorinated polymer coating layers is dependent upon the volume percentage of fluorine contained within the layers. Increased fluorine content decreases the refractive index of the coating layers.

However, increasing the fluorine content also decreases the surface energy of the coating layers, which in turn reduces the interfacial adhesion of the fluoropolymer layer to the other polymer or substrate layers to which the layer is coupled.

Other materials investigated for use in low refractive index layers are silicone-containing polymeric materials. Silicone-containing polymeric materials have generally low refractive indices. Further, silicone-containing polymeric coating layers generally have higher surface energies than fluoropolymer-base layers, thus allowing the silicone-containing polymeric layer to more easily adhere to other layers, such as high refractive index layers, or substrates. This added adhesion improves scratch resistance in multilayer antireflection coatings. However, silicone-containing polymeric materials have a higher refractive index as compared with fluorine containing materials. Further, in general, silicone-containing polymeric materials have a lower viscosity that leads to defects in ultra-thin coatings (less than about 100 nanometers).

Thus, it is highly desirable to form a low refractive index layer for an antireflection film having increased fluorine content, and hence lower refractive index, while improving interfacial adhesion to accompanying layers or substrates.

Further, it is highly desirable to form this material for use in a transferable antireflection film that utilizes this the improved low refractive index layer.

### SUMMARY OF THE INVENTION

The present invention provides a method for forming a transferable antireflection film having a high refractive index layer, a low refractive index layer, and a release layer. The formed transferable antireflection material is then applied directly to or indirectly to an optical substrate, and the release layer removed, leaving an antireflection film coated to the optical substrate.

One method for application of the transferable material to the substrate is through the use of an in-mold or heat press technique. Another method for applying the transferable material to the substrate is by an ultraviolet exposure technique.

The film is formed prior to application to the substrate and has at least one low refractive index layer and at least one high refractive index layer coupled to a release film. The low index reflection layer has good durability and low refractivity, while also having appropriate adhesion to the release layer and having good adhesion to high index refraction layer.

The low refractive index layer is formed from a silicone-modified fluoropolymer that is formed by first dissolving a fluoropolymer having at least one monomer of vinylidene fluoride coupled to a hexafluoropropylene monomer unit in an organic solvent and subsequently reacting the mixture with an amino silane coupling agent to form an aminosilane-modified fluoropolymer. The aminosilane fluoropolymer is subsequently heated and partially condensed with an oligomer of a silane compound including alkoxy silane.

Other objects and advantages of the present invention will become apparent upon considering the following detailed description and appended claims, and upon reference to the accompanying drawings.

### BRIEF DESCRIPTION OF THE DRAWINGS

FIGS. 1A and 1B is a schematic illustration of an article having an antireflection material according to one embodiment of the present invention;

FIG. 2 is a schematic illustration of a method of forming and applying a transferable antireflection material to an optical substrate according to one embodiment of the present invention;

FIGS. 3-5 is a schematic illustration of a method of forming and applying a transferable antireflection material to an optical substrate according to another preferred embodiment of the present invention;

FIGS. 6-7 is a schematic illustration of a method of forming and applying a transferable antireflection material to an optical substrate according to another preferred embodiment of the present invention; and

FIGS. 8-9 is a schematic illustration of a method of forming and applying a transferable antireflection material to an optical substrate according to another preferred embodiment of the present invention.

### DETAILED DESCRIPTION AND PREFERRED EMBODIMENTS OF THE INVENTION

For the following defined terms, these definitions shall be applied, unless a different definition is given in the claims or elsewhere in the specification.

The term “polymer” will be understood to include polymers, copolymers (e.g. polymers using two or more different monomers), oligomers and combinations thereof, as well as polymers, oligomers, or copolymers that can be formed in a miscible blend.

The term “low refractive index”, for the purposes of the present invention, refers to the property of a composition or material, which forms a coating layer having a refractive index of less than about 1.42 when applied as a layer to a substrate.

The term “high refractive index”, for the purposes of the present invention, refers to the property of a composition or material, which forms a coating layer having a refractive index of greater than about 1.6 when applied as a layer to a substrate.

However, in general terms, all that is required is that the low refractive index layer is formed having a refractive index less than a high refractive index layer. Thus, coating layers wherein the low refractive index layer having a refractive index slightly greater than about 1.42, when coupled with a high refractive index layer having a refractive index slightly less than about 1.6, wherein the refractive index of the low refractive index layer is less than the refractive index of the high refractive index layer, are also specifically contemplated by the present invention.

The recitation of numerical ranges by endpoints includes all numbers subsumed within the range (e.g. the range 1 to 10 includes 1, 1.5, 3.33, and 10).

As used in this specification and the appended claims, the singular forms “a”, an and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

Unless otherwise indicated, all numbers expressing quantities of ingredients, measurements of properties such as contact angle and so forth as used in the specification and claims are to be understood to be modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters set forth the broad scope of the invention are approximations, the numerical values set forth in the specific examples reported as accurately as possible. Any numerical value, however, inherently contains certain errors necessarily resulting from the standard deviations found in their respective testing measurements.

The present invention is directed to a transferable antireflection material used on optical substrates. The optical substrates include various illuminated and non-illuminated displays panels wherein a combination of low surface energy (e.g. anti-soiling, stain resistant, oil and/or water repellency) and durability (e.g. abrasion resistance) is desired while maintaining optical clarity. The antireflection material functions to decrease glare and decrease transmission loss while improving durability and optical clarity.

The surface energy can be characterized by various methods such as contact angle and ink repellency, as determined by the test methods described in the examples. The surface layer and articles described preferably exhibit a static contact angle with water of at least 70 degrees. More preferably, the contact angle is at least 80 degrees and more preferably at least 90 degrees. Alternatively, or in addition thereto, the advancing contact angle with hexadecane is at least 50 degrees and more preferably at least 60 degrees. Low surface energy is indicative of anti-soiling properties as well as rendering the exposed surface easy to clean.

Another indicator of low surface energy relates to the amount of ink from a pen or marker, which beads up when applied to the exposed surface. The surface layer and articles exhibit “ink repellency” when the ink from pens and markers can be easily removed by wiping the exposed surface with a tissues or paper towels, such as tissues available from the Kimberly Clark Corporation, Roswell, Ga. under the trade designation “SURPASS FACIAL TISSUE.”

Such displays include multi-character and especially multi-character, multi-line displays such as liquid crystal displays (“LCDs”), plasma displays, front and rear projection displays, cathode ray tubes (“CRTs”), signage, as well as single-character or binary displays such as light emitting tubes (“LEDs”), signal lamps and switches. The light transmissive (i.e. exposed surface) substrate of such display panels may be referred to as a “lens.” The invention is particularly useful for displays having a viewing surface that is susceptible to damage.

The coating composition, reactive product thereof, as well as the protective articles of the invention can be employed in a variety of portable and non-portable information display devices including PDAs, cell phones (including combination PDA/cell phones), touch sensitive screens, wrist watches, car navigation systems, global positioning systems, depth finders, calculators, electronic books, CD and DVD players, projection televisions screens, computer monitors, notebook computer displays, instrument gauges, instrument panel covers, signage such as graphic displays and the like. These devices can have planar viewing faces, or non-planar viewing faces such as slightly curved faces.

The coating composition, reactive product thereof, as well as the protective articles of the invention can be employed on a variety of other articles as well such as, for example, camera lenses, eyeglass lenses, binocular lenses, retroreflective sheeting, automobile windows, building windows, train windows, aircraft windows, vehicle headlamp and taillights, and the like. The above listing of potential applications should not be construed to unduly limit the invention.

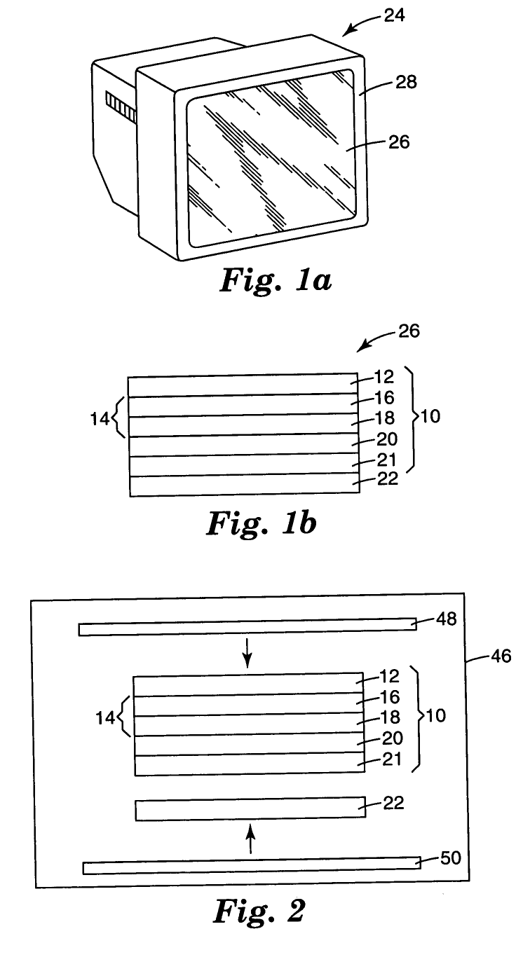

Referring now to FIGS. 1A and 1B, a perspective view of an article, here shown as a computer monitor 24, is illustrated as having an optical display 26 coupled within a housing 28. The optical display 26 is formed by applying a transferable antireflection material 10 to an optical substrate 22, which is preferably glass or a polymeric material such as polyethylene terephthalate (“PET”).

The transferable antireflection material 10 is formed having at least one release film layer 12 and an antireflection layer 14 having at least two interference layers 16, 18, one of which is a low index reflection layer 16 and the other of which is a high index reflection layer 18.

The transferable antireflection material 10 can also consist of an optional adhesive layer 21 and/or a hard coat layer 20, which is utilized as the interface layer to the substrate 22. Alternatively, the adhesive layer 21 or hard coat layer 20 can also be applied directly to the substrate layer 22 prior to the introduction of the transferable antireflection material 10.

Transferable antireflection materials 10 according to the present invention can be applied, after formation, to the substrate 22 to form the optical display 26 by either of two techniques.

One preferred technique is described generically as a thermal application technique. The thermal application technique can apply the transferable antireflection film 10 to the substrate 22 via a heat transfer method, as described below in FIG. 2, or via an in-mold transfer process, as described below in FIGS. 3-5.

The other preferred technique for applying the material 10 to the substrate 22 is via an ultraviolet radiation exposure method. Two separate methods of using ultraviolet radiation to apply the transferable antireflection material 10 to the optical substrate 22 are described below with respect to FIGS. 6-7 and 8-9, respectively.

FIGS. 2 and 3 below illustrate two methods for forming an optical display via a thermal application technique. The process for either technique begins by first forming the transferable antireflection film 10. The deviation in either process involves the subsequent application of the transferable film to the optical substrate 22. To form the transferable antireflection film 10, the antireflection coating layers 14 are first applied, one layer at a time, to a temporary transferring material known as a release layer 12.

The release layer 12 is preferably a material that is capable of adhering any layer of coating applied to it for storage and transport. The release layer 12 also has a stable transfer performance of the antireflection material 14 to the substrate 22 during the subsequent application stage. One preferred release layer meeting these requirements is polyethylene terephthalate film, or PET film, having a thickness of about 25-75 microns.

Next, a wet layer of low refractive index 16 is applied to the release layer 12 using a Mayer bar or similar device. This wet layer 16 is then dried in an oven to a preferred dry thickness of about 75-100 nanometers.

The low index reflection layer 16 is preferably a silicone-modified fluoropolymer material having good durability and low refractivity. The layer 16 also has appropriate adhesion to the release layer 12 and adequate adhesion to the later-applied high index refraction layer 18.

One preferred composition for use in forming the low refractive index layer 16 is described in co-pending application No. ______ (60428US002, SM4061), which is herein incorporated by reference, as a silicone-modified fluoropolymer that is formed by first dissolving a fluoropolymer having at least one monomer of vinylidene fluoride coupled to a hexafluoropropylene monomer unit in an organic solvent and subsequently reacting the mixture with an amino silane coupling agent to form an aminosilane-modified fluoropolymer. The aminosilane fluoropolymer is subsequently heated and partially condensed with an oligomer of a silane compound including alkoxy silane.

Next, a wet layer of a high index refraction material is applied to the dried low refraction index layer 16 using a Mayer bar or similar device. The high index material is dried in an oven and irradiated with an ultraviolet light source from the PET film 12 side to form a high index layer 18 having a thickness of about 100-125 nanometers.

The main component of the high index matrix resin is a monomer or an oligomer having one or more ultraviolet light (“UV”) curable double bonds in order that the resultant layer 18 formed has sufficient cohesion force (by high cross-linking density). Due to reaction speed, acrylic monomers or oligomers are desirable for use as the high index matrix resin.

To increase the cross-linking density within the layer 18, multi-functional monomers or oligomers are also utilized as a portion of the matrix resin. Two preferred multi-functional acrylates that are utilized are Dipentaerithriotal penta/hexaacrylate (DPHA) and pentaerithritol tri/tetra acrylate (PETA).

In addition, it is also desirable to use a multi-functional epoxy acrylate as a portion of the matrix resin to improve scratch resistance performance. Two preferred multifunctional epoxy acrylates that may be used are Bisphenol A epoxy acrylate and Cresol novolac epoxy acrylate.

Zirconium dioxide (“ZrO₂”) and titanium dioxide (“TiO₂”) are desirable particles for use in high index refractive layers 18. The particle size of the high index inorganic particles is preferably less than about 50 nm in order that it is sufficiently transparent. When electric conductivity is necessary, indium tin oxide (“ITO”) and antimony tin oxide (“ATO”) are desirably used.

These high index particles are first mixed with an organic solvent by using common organosol preparation methods. One example is to prepare a sol in water and then replace the water slowly with organic solvent. Another example is to first disperse the dried particles in organic solvents. In one embodiment, dried rutile fine TiO₂ particles are dispersed with dispersant in an organic solvent using a sand mill. The particles are then introduced to the matrix resin to form the high index composition for the layer 18.

In order to increase adhesion of the high refractive index layer 18 to the low refractive index layer 16, it is desirable that the composition of the high refractive layer 18 includes alkoxy silyl groups. To accomplish this, it is desirable to include a silane coupling agent in the component of the high index layer. Since the high index layer is preferably an acrylates bond material, silane coupling agent with acrylic functional group is preferably utilized.

The reaction mechanism for forming the aminosilane modified fluoropolymer preferentially and substantially occurs at vinylidene fluoride groups that are located next to HFP groups in the THV or FKM molecules. The reaction mechanism is a dehydrofluorination reaction of the VdF group followed by an Michael addition reaction.

Because the low refractive index layer 16 mentioned above also includes alkoxy silyl groups, siloxane bonding will occur at the layer interface when the high index layer 18 is cured. These siloxane bonds are believed to improve scratch resistance of the transferable material 10 after application to the substrate 22.

During the UV curing process of the high index layer 18, UV irradiation of more than 300 nm should be utilized to prevent the low index layer 16 from increasing adhesion to the PET release layer 12 to undesirable levels, therein adversely affecting the subsequent release performance of the release layer 12. For this reason as well, UV exposure of the high index layer 18 is preferably done from the PET side 12 to filter off the short UV light ranges. Since this high index layer 18 is very thin, typically around 100 nm, it is also desirable to irradiate the layer under an inert gas atmosphere to substantially prevent oxygen free radical damage that may occur.

As the solvent of the high index layer 18 solution, alcohol solvents are desirable considering the surface tension and solubility of the low index layer 16. Isopropyl alcohol (“IPA’) is thought to be the best. To help the solubility of the high matrix resin 18 and to control the drying speed of the high index layer 18, other organic solvents such as methyl ethyl ketone (“MEK”) and butyl cellosolve can also be used.

Next, a wet layer of a hard coating material, such as layer 20, is applied to the high refractive index layer 18 using a Mayer bar or similar device. The hard coating film is dried in an oven and exposed to an ultraviolet light source, from the PET film 12 side. This forms a hard coating layer having a thickness of about 5 microns. A corona discharge treatment is next optionally and preferably applied to the exposed surface of the hard coat layer 20.

The purpose of the hard coating layer 20 is to prevent scratching. The scratch resistance of the layer is dependent upon the crosslinking density of the hard coating layer 20. Further, the adhesion of the hard coat layer 20 to the high refractive index layer 18 is partially dependent upon the compatibility of the hard coating layer 20 to the high index refraction layer 18.

As such, a desirable hard coating composition for use in the present invention is an acrylic UV curable system that increases the interfacial adhesion to the overlying acrylic high refractive index layer 18. Further, the use of a multifunctional acrylic monomer and a multifunctional polyurethane acrylate is desirable. For improved flexibility, difunctional acrylate resins are preferred over trifunctional or higher order acrylate resins.

Next, an adhesive material 21, such as layer 21, is applied to the hard coating layer 20 using a Mayer bar or similar device and dried in an oven to form an adhesive layer. The corona discharge treatment previously applied to the hard coating layer 20 acts to increase the interfacial adhesion between the hard coating layer 20 and the adhesive layer 21. Preferably, the adhesive layer 21 has a thickness of about 2 micrometers. The adhesive layer 21 is chosen based on its affinity with the substrate material 22 and hard coating layer 20 to which it is applied. Copolymers of polyvinyl chloride/polyvinyl acetate and acrylic polymers are preferably used for this purpose.

Thus, the transferable antireflection layer 10 of FIGS. 2 and 3 is fully formed and is stored until needed.

As described further in FIG. 2, the transferable antireflection layer 10 and optical substrate 22 are placed into a heat mold 46, with the adhesive layer 21 being closely coupled to the substrate 22. The mold 46 is then closed. A heated upper plate 48 is pressed at a first pressure onto the release layer 12, while a heated lower plate 50 is pressed in the opposite direction onto the substrate 22 for a predetermined amount of time sufficient to adhere the adhesive layer 21 to the substrate 22. The mold 46 is then opened, and the optical substrate having the coupled transferable layer 10 is removed and cooled. Next, the release layer 12 is peeled away from the low refraction index layer 16. The result is a transferable antireflection film 10 being applied to the optical substrate 22.

Alternatively, as described in FIG. 3, the transferable antireflection film 10 can be applied to an optical substrate 22 as the optical substrate is being formed via an in-mold transfer process as described below in FIGS. 3-5.

Referring to FIG. 3, the transferable antireflection film 10 is first placed within an injection mold 73 between a first piece 75 and a second piece 77. The release layer 12 is closely coupled to the second piece 77 and away from the first piece 75.

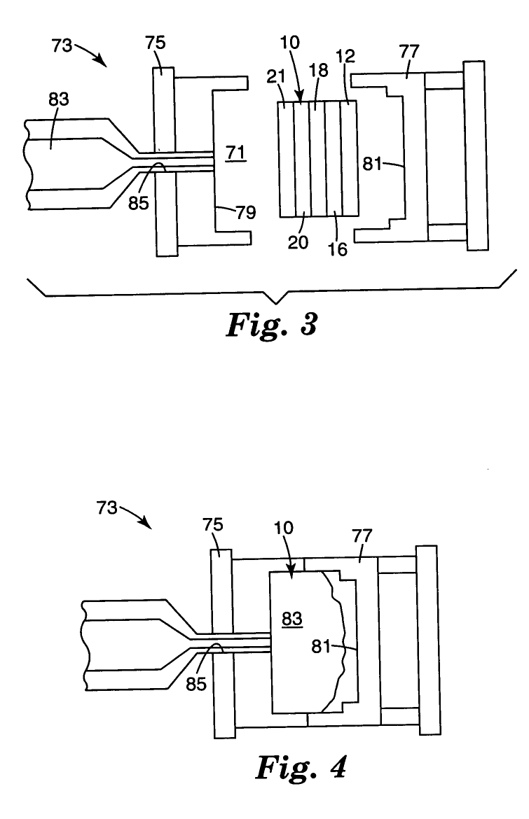

The mold 73 is closed, as shown in FIG. 4, and the transferable film 10 is contained within a cavity 71 defined by the inner surfaces 79, 81 of the first piece 75 and second piece 77, respectively. A quantity of molten optical substrate polymeric material 83 is introduced (i.e. injected) through an opening 85 within the first piece 75 at a predetermined temperature and pressure. The molten material 83 fills the cavity 71 and causes the transferable film 10 to be pressed against the inner surface 81 of the second piece 77. The molten material 79 is then cooled to form the optical substrate 22. The interaction between the adhesive layer 21 and cooled substrate 22 creates adhesion to couple the transferable antireflection film 10 to the formed substrate.

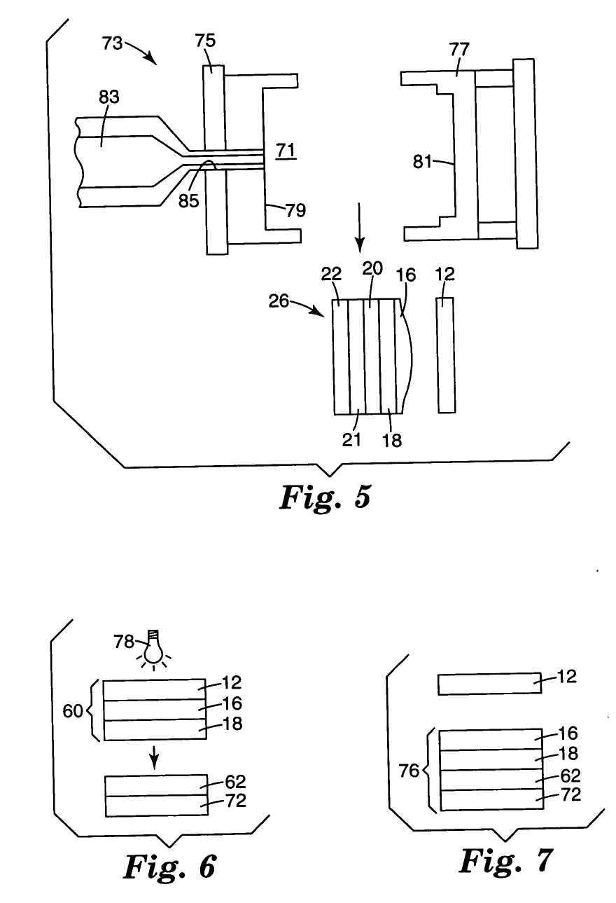

Finally, as shown in FIG. 5, the mold 73 is opened, and the optical substrate and transferable film 10 are removed from the cavity 71. The release layer 12 is then peeled away from the low refraction index layer 16, leaving the formed optical display.

FIGS. 6-7 and 8-9 illustrate two alternative preferred embodiments for applying the transferable antireflection layer to an optical substrate using an ultraviolet radiation exposure technique.

Referring to FIGS. 6 and 7, a transferable layer 60 is formed having the release layer 12, low refraction index layer 16, and high refraction index layer 18, formed in a similar manner as described above in FIGS. 2 and 3. However, in this embodiment, a UV adhesive layer 62 is applied directly to a substrate 72 of an optical device, and is not a part of the transferable layer 60.

The UV adhesive layer 62 has the same composition as the hardcoat layer 20 as described above in FIGS. 1-5 and is applied to the substrate 72 in the same manner as the hard coat layer 20 is applied to the high refractive layer as described above. The hardcoat adhesive layer 62 may optionally be irradiated with an ultraviolet light source to adhere the layer 62 to the substrate.

To form an optical device 76 having the antireflection film 60 placed upon the optical device substrate 72, as best shown in FIG. 6, the transferable layer 60 is placed onto the adhesive layer 62 such that the high refractive index layer 18 substantially abuts the adhesive layer 62. An ultraviolet light source 78 is positioned such that the transferable layer 60 is between the adhesive layer 62 and the release layer 12. The ultraviolet light source is then irradiated at a sufficient intensity to cure the adhesive layer 62 and adhere the adhesive layer 62 to the high refractive index layer 18. The intensity of the irradiation, however, should be insufficient to cause further adherence of the low refractive index layer 16 to the release layer 12. The ultraviolet light source 78 is removed and the optical substrate 72 having the coupled transferable layer 60 is cooled. Next, as shown in FIG. 7, the release layer 12 is peeled away from the low refraction index layer 16. The result is an antireflection film 74 being coupled to layer 62 of the optical substrate 72.

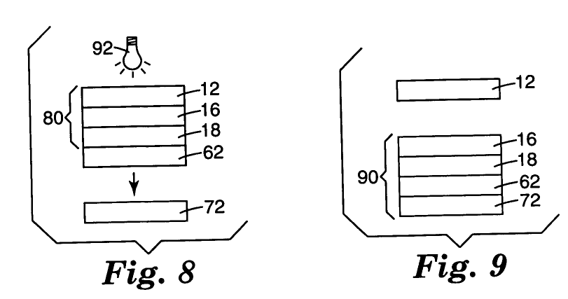

In yet another embodiment, as shown in FIG. 8 and 9, a transferable layer 80 is formed having the release layer 12, low refraction index layer 16, and high refraction index layer 18 as described above. However, in this preferred embodiment, the UV adhesive layer 62 is applied, and optionally UV cured, to the high refraction index layer 18 and is a portion of the transferable layer 60.

To form an optical device 90 having the antireflection film 80 placed upon its substrate 72, as best shown in FIG. 8, the transferable layer 80 is placed onto the substrate 72 such that the adhesive layer 62 substantially abuts the substrate 72. An ultraviolet light source 92 is positioned such that the transferable layer 80 is between the substrate 72 and the release layer 12. The ultraviolet light source 92 is then irradiated at a sufficient intensity to cure the adhesive layer 62 and adhere the adhesive layer 62 to the substrate 72. The intensity of the irradiation, however, should be insufficient to cause further adherence of the low refractive index layer 16 to the release layer 12.

The ultraviolet light source 92 is removed and the optical substrate 72 having the coupled transferable layer 80 is cooled. Next, as shown in FIG. 9, the release layer 12 is peeled away from the low refraction index layer 16. The result is an antireflection film being coupled with a hard coating layer to the optical substrate.

The present transferable antireflection material offers several advantages over the prior art. First, the invented material does not have strong adhesion to the PET film, so stable transfer is achieved without an additional release layer. Second, the high index refraction layer is stably constructed on the low index layer without causing a dewetting problem. Third, because the low index refraction layer includes numerous functional groups to form siloxane bonds, the resultant material achieves high durability. Fourth, the low index refraction layer is porous enough to allow the high index refraction layer to partially penetrate upon application, therein improving adhesion between the layers, which results in improved scratch resistant in the overall coating layer.

### EXAMPLES

To make transferable AR material, the following solutions for low index layers, high index layers, hard coating layers, adhesive layers and UV curable adhesive layers were prepared.
1. Preparation of Solution for Low Index Layer
   Preparation of L-1 (Modification of Fluoro-Elastomer):

40 g of FT-2430 (Dyneon) is first dissolved in MEK and 400 g of a 10 weight percent solution was prepared. In the solution, 1001.4 g of THF and 2.11 g of amino silane coupling agent (KBM-903, Shinetsu Chemical) were added and mixed. The resultant solution was allowed to sit in an airtight container for 10 days under ambient conditions. After 10 days, the resultant solution was a little yellow. The solids percentage was 3.0 weight percent and the weight ratio of FT-2430/KBM-903 was about 95/5.

Preparation of L-1 (Condensation with Silicone Alkoxy Oligomer):

400 g of the modified polymer solution, 72 of organic alkoxy silane oligomer (SI oligomer 2, GE Toshiba Silicone), 50 g of oligo tetra methoxy silane (X40-2308, Shinetsu Chemical), 24 g of THF and 54 g of PMA were mixed. When coated by Mayer bar, the resultant coating appeared hazy.

This mixture was then kept in 80° C. water bath for 1.5 hours. When coated by Mayer bar, the resultant coating showed a transparent appearance without haze. Solids percentage was 10 weight percent and F-polymer/Organic silicone oligomer/Oligo methoxy silane ratio was maintained at 15/22.5/62.5.

Just after reaction completion, 290 g of the reaction product described above is thinned with 448.2 g of THF, 502.5 g of MEK, 335 g of MIBK and 172.7 g of Cyclohexanone. Moreover, 8.7 g of a 10% solution of Dibutyltin dilaurate in MEK was added to the resultant mixture, named L-1.

Preparation of L-2:

A Copolymer of Tetrafluoroethylene (TFE), Hexafluoropropylene (HFP), and Vinylidenefluoride (VdF) (Product name: THV220, Dyneon) was dissolved in Methyl Ethyl Ketone (MEK) to form a 10 weight percent solution. 3 g of the 10% THV solution was further diluted with 1.5 g of Ethyl Acetate and 0.5 g of N-methyl Pyrrolidinone. This solution was named as L-2, and the solids percentage was maintained at 1.5 weight percent.

Preparation of L-3:

Solution L-3 was a commercially available solution of UV curable fluorinated acrylic compound (Product name: TM011, JSR) diluted with Methyl Isobutyl Ketone (MIBK) to 1.5 weight percent solids.

Preparation of L-4:

Solution L-4 was a commercially available oligo organo silane material (Product name: SI oligomer 2, GE Toshiba Silicone) diluted with to 2.0 weight percent solids in IPA.
2. Preparation of Solution for Low Index Layer
   Preparation of TiO2 Dispersion:

500 g of TiO₂ particles with Rutile structure (Product name: TTO-V-3, Ishihara), 250 g of dispersant (Product name: Disperbyk 2000, BYK Chernie), 1040 g of IPA, and 210 g of Butyl Cellosolve were mixed well to obtain a TiO₂ dispersion. The solids percentage of the dispersion was adjusted to 22.1 weight percent.

Preparation of Oligomer of Silane Coupling Agent (5103Hv):

In a covered glass bottle, 5 g of acryloxypropyl methoxy silane (Product name: KBM5103, Shinetsu Chemical), 3.62 g of deionized water, 0.22 g of 0.1N aqueous hydrochloric acid and 6 g of IPA were mixed together. This mixture was kept in 80° C. oven for 12 hours. The final solids percentage was adjusted to 23.5 weight percent.

Preparation of Solution for High Index Layer (H-1):

1 g of the TiO₂ dispersion described above was mixed in a glass bottle with 13.92 g of IPA, 1.4 g of MEK, 0.87 g of Butyl Cellosolve, and the mixture was treated with ultrasonic agitation for 5 minutes. To this mixture was added 1.22 g of Novolac epoxy acrylate (Product name: NK oligo EA-7420, ShinNakamura Chemical), 1.22 g of Pentaerythritol tri/tetra acrylate (Product name: NK ester A-TMM-3, ShinNakamura Chemical), 0.26 g of 5103Hy described above, 0.18 g of a 5 weight percent solution of photo-initiator (Product name: Irgacure 369, Ciba Specialty Chemical) in MEK and 0.18 g of a 5 weight percent solution of Dibutyltin dilaurate in MEK. The resultant mixture was stirred and the solids percentage was adjusted to about 2.6 weight percent.

Preparation of Solution for High Index Layer (H-2):

1 g of the TiO₂ dispersion described above was mixed in a glass bottle with 14.12 g of IPA, 0.85 g of MEK, 0.87 g of Butyl Cellosolve, and the mixture was treated with ultrasonic agitation for 5 minutes. To this mixture was added 1.53 g of Novolac epoxy acrylate (Product name: NK oligo EA-7420, ShinNakamura chemical), 1.53 g of Pentaerythritol tri/tetra acrylate (Product name: NK ester A-TMM-3, ShinNakamura chemical), 0.18 g of a 5 weight percent solution of photo-initiator (Product name: Irgacure 369, Ciba specialty chemical) in MEK and 0.18 g of a 5 weight percent solution of Dibutyltin dilaurate in MEK. The resultant mixture was stirred and the solids percentage was adjusted to 2.6 weight percent.

Preparation of Solution for High Index Layer (H-3):

1 g of the TiO2 dispersion described above was mixed in a glass bottle with 13.92 g of IPA, 1.4 g of MEK, 0.87 g of Butyl Cellosolve, and the mixture was treated with ultrasonic agitation for 5 minutes. To this mixture was added 2.44 g of Pentaerythritol tri/tetra acrylate (Product name: NK ester A-TMM-3, ShinNakamura chemical), 0.26 g of 5103Hy described above, 0.18 g of a 5 weight percent solution of photo-initiator (Product name: Irgacure 369, Ciba specialty chemical) in MEK and 0.18 g of a 5 weight percent solution of Di-butyltin dilaurate in MEK. The resultant mixture was stirred and the solids adjusted to 2.6 weight percent.

Preparation of Solution for High Index Layer (H-4):

1 g of a TiO₂ dispersion described above was mixed in a glass bottle with 13.92 g of IPA, 1.4 g of MEK, 0.87 g of Butyl Cellosolve, and the mixture was treated with ultrasonic agitation for 5 minutes. To this mixture was added 2.44 g of Novolac epoxy acrylate (Product name: NK oligo EA-7420, ShinNakamura Chemical), 0.26 g of 5103Hy described above, 0.18 g of a 5 weight percent solution of photo-initiator (Product name: Irgacure 369, Ciba Specialty Chemical) in MEK and 0.18 g of a 5 weight percent solution of Di-butyltin dilaurate in MEK. The resultant mixture was stirred and the solids percentage was adjusted to 2.6 weight percent.
3. Preparation of Solution for Hard-Coating (HC-1)

In a glass bottle, 3 g of a 50 weight percent solution of polyurethane acrylate (Product name: U-15HA, ShinNakamura chemical) in Toluene, 1.5 g of Pentaerythritol tri/tetra acrylate (Product name: NK ester A-TMM-3, ShinNakamura chemical), 1.29 g of 1.6-Hexanediol diacrylate (Product name: NK ester A-HD-N, ShinNakamura chemical), 2.14 g of 10 weight percent solution of photo-initiator (Product name: Irgacure 184, Ciba specialty chemical) in Toluene and 3.32 g of Toluene were mixed and stirred. The solids percentage was adjusted to 40 weight percent.
4. Preparation of Solution for Adhesive Layer (Adh-1)

In a glass bottle, 10 g of a 20 weight percent solution of acrylic polymer (Product name: Paraloid B-44, Rohm & Haas) in MEK, 2.2 g of MEK and 1.13 g of Cyclohexanone were mixed and stirred well. The solids percentage was adjusted to 15 weight percent.
5. Preparation of Solution for UV Curable Adhesive Layer
   Preparation of UVADH-1:

In a glass bottle, 2 g of 50 weight percent solution of polyurethane acrylate (Product name: UA-32P, ShinNakamura Chemical) in Toluene, 0.22 g mono acrylate with carboxylic acid (Product name: HOA-MS, Kyoeisya Chemical), 0.56 g of 10 weight percent Toluene solution of photo-initiator (Product name: Irgacure 184, Ciba Specialty Chemical), 0.11 g of 30 weight percent Toluene solution of silane coupling agent (Product name: KBM5103, Shinetsu Chemical) and 0.8 g of Toluene were mixed and stirred. The mixture was named as UVADH-1 and the solids percentage was adjusted to 40 weight percent.

Preparation of UVADH-2:

For this material, a commercial UV curable hard-coating agent (Product name: UR6530, Mitsubishi rayon) was used.

With those solutions, various transferable AR materials were produced.

### Example 1

On 75 um PET (Product name: O-75, Teijin), L-1 described above was coated by Mayer bar #6 and dried in 80° C. oven for 30 seconds and then put in 120° C. oven for 20 seconds to make a low index layer with approximately 90 nm thickness. On the low index layer, H-1 was coated by Mayer bar #8 and dried in 80° C. oven for 30 seconds and then put in 120° C. oven for 20 seconds. The H-1 coated film was UV exposed for 8 seconds from the PET release layer side with a 120 W Fusion lump (D bulb) under nitrogen gas atmosphere to make a high index layer with approximately 130 nm thickness. On the high index layer, HC-1 was coated by Mayer bar #10 and dried in 80° C. oven for 60 seconds. This coated film was UV exposed for 8 seconds from the PET release layer side with a 120 W Fusion lump (D bulb) under N2 atmosphere to make hard coating layer with approximately 5 um thickness. Moreover, on the hard coating layer, Adh-1 was coated by Mayer bar #9 and dried in 80° C. oven for 60 seconds to make adhesive layer with approximately 2 um thickness and then transferable AR material named TAR-1 was completed.

In the next step, TAR-1 and a commercial acrylic board with 7 cm square and 2 mm thickness were put together and inserted into a heat-press machine with two metal plates and heat-pressed for 40 seconds with 30 MPa pressure. The temperatures of the plates were 180° C. for film/acrylic side and 50° C. for the opposite side. The pressed materials were taken out and PET film was removed after cooling. As a result, the anti-reflection layer was successfully transferred on the acrylic surface.

### Example 2

TAR-1 in Example 1 was inserted into a molding die and PMMA was injection molded with 240° C. injection temperature. The pressed materials were taken out and PET film was removed after cooling. As a result, the anti-reflection layer was successfully transferred on the molding surface.

### Example 3

The same procedure was taken to make TAR-2 except using H-3 in Example 1.

In the next step, TAR-2 and a commercial acrylic board with 7 cm square and 2 mm thickness were put together and inserted into a heat-press machine with two metal plates and heat-pressed for 40 seconds with 30 MPa pressure. The temperatures of the plates were 180° C. for film/acrylic side and 50° C. for the opposite side. The pressed materials were taken out and PET film was removed after cooling. As a result, the anti-reflection layer was successfully transferred on the acrylic surface.

### Example 4

The same procedure was taken to make TAR-3 except using H-4 for H-1 in Example 1.

In the next step, TAR-3 and a commercial acrylic board with 7 cm square and 2 mm thickness were put together and inserted into a heat-press machine with two metal plates and heat-pressed for 40 seconds with 30 MPa pressure. The temperatures of the plates were 180° C. for film/acrylic side and 50° C. for the opposite side. The pressed materials were taken out and PET film was removed after cooling. As a result, the anti-reflection layer was successfully transferred on the acrylic surface.

### Example 5

On 75 um PET (Product name: O-75, Teijin), L-1 described above was coated by Mayer bar #6 and dried in 80° C. oven for 30 seconds and then put in 120° C. oven for 20 seconds to make a low index layer with approximately 90 nm thickness. On the low index layer, H-1 was coated by Mayer bar #8 and dried in 80° C. oven for 30 seconds and then put in 120° C. oven for 20 seconds. The H-1 coated film was UV exposed for 8 seconds from the release layer side with a 120 W Fusion lump (D bulb) under nitrogen gas atmosphere to make high index layer with approximately a 130 nm thickness and then transferable AR material named TAR-4 was completed.

Further, UVADH-2 was coated by a Mayer bar #6 to make an approximately 6 um coating layer on a commercial 2 mm acrylic sheet. On it, TAR-4 was laminated by rubber roll and UV exposed for 8 seconds from the release layer side with a 120 W Fusion lump (D bulb). After UV exposure, the PET release layer was removed and the anti-reflection layer was successfully transferred onto the acrylic surface.

### Example 6

On 75 um PET (Product name: O-75, Teijin), L-1 described above was coated by Mayer bar #6 and dried in 80° C. oven for 30 seconds and then put in 120° C. oven for 20 seconds to make low index layer with approximately 90 nm thickness. On the low index layer, H-1 was coated by Mayer bar #8 and dried in an 80° C. oven for 30 seconds and then put in a 120° C. oven for 20 seconds. This coated film was UV exposed for 8 seconds from the release layer side with a 120 W Fusion lump (D bulb) under nitrogen gas atmosphere to make high index layer with approximately 130 nm.

On the high index layer, UVADH-1 was coated by knife and dried in 80° C. oven for 60 seconds. Silicone coated PET was laminated on the TVADH-1 and the transferable AR material named TAR-5 was completed.

After removing the silicone liner from TAR-5, the film was laminated on commercial acrylic sheet with 7 cm square and 2 mm thickness and UV was exposed for 8 seconds from no coating side with a 120 W Fusion lump (D bulb). After UV exposure, PET was removed and the anti-reflection layer was successfully transferred on the acrylic surface.

### Comparison Example 1

The same procedure was taken to make TAR-6 except using L-2 for L-1 in Example 1.

In the next step, this TAR-6 and commercial acrylic sheet with 7 cm square and 2 mm thickness were put together and were inserted into a heat-press machine with two metal plate and heat-pressed for 40 seconds with 30 MPa pressure. The temperatures of the plates were 180° C. for film/acrylic side and 50° C. for the opposite side. The pressed materials were taken out and PET film was removed after cooling. As a result, the breaking portion was the interface of low index layer and high index layer and antireflection material transfer failed. The reason for the failure was attributed to too much adhesion of the low index layer to the PET release layer.

### Comparison Example 2

The same procedure was taken to make TAR-7 except using L-4 for L-1 in Example 1.

In the next step, this TAR-7 and commercial acrylic sheet with 7 cm square and 2 mm thickness were put together and were inserted into a heat-press machine with two metal plates and heat-pressed for 40 seconds with 30 MPa pressure. The temperatures of the plates were 180° C. for film/acrylic side and 50° C. for the opposite side. The pressed materials were taken out and PET film was removed after cooling. As a result, the breaking portion was the interface of low index layer and high index layer and antireflection material transfer failed. The reason for the failure was attributed to too much adhesion of the low index layer to the PET release layer.

### Comparison Example 3

On 75 um PET (Product name: O-75, Teijin), L-3 described above was coated by Mayer bar #6 and dried in 80° C. oven for 30 seconds and then put in 120° C. oven for 20 seconds to make low index layer with approximately 90 nm thickness. On the low index layer, H-1 was coated by Mayer bar #8 and dried in 80° C. oven for 30 seconds, however during drying, the organic solvent in high index layer dissolved the low index layer. As a result, some surface imperfection (pattern) was observed on the high index layer and the experiment was suspended.

### Comparison Example 4

On 75 um PET (Product name: O-75, Teijin), L-3 described above was coated by Mayer bar #6 and dried in 80° C. oven for 30 seconds and then put in 120° C. oven for 20 seconds. This coated film was UV exposed for 8 seconds from the PET side with a 120 W Fusion lump (D bulb) under nitrogen gas atmosphere to make low index layer with a thickness of approximately 90 nm. However, when high index layer solution was coated on the low index layer, severe dewetting phenomenon was observed and high index layer was not constructed successfully.

### Comparison Example 5

The same procedure was taken to make TAR-8 except using H-2 for H-1 in Example 1.

In the next step, this TAR-8 and commercial acrylic board with 7 cm square and 2 mm thickness were put together and were inserted into a heat-press machine with two metal plates and heat-pressed for 40 seconds with 30 MPa pressure. The temperatures of the plates were 180° C. for film/acrylic side and 50° C. for the opposite side. The pressed materials were taken out and PET film was removed after cooling. As a result, the anti-reflection layer was successfully transferred on the acrylic surface.

### Comparison Example 6

Commercial acrylic sheet with 2 mm thickness was used without any treatment.

For the examples and comparison examples, the following properties were evaluated:

Spectral: A black PVC sheet was put on the opposite side of the antireflection treatment by PSA and spectral reflectance at 580 nm was measured by spectrometer, F-20 (Filmetrics). For this measurement, a measurement position, where minimum reflection is located in 580 nm, were selected and used. (For blank acrylic sheet in comparison Example 6, reflectance at 580 nm was measured.)

Scratch resistance: Very fine steel wool (#0000 steel wool) was used to test a 1 cm sample of the antireflection film. Samples were tested using 10 cycles of rubbing with a 100-500 kgf/cm2 load. The samples were evaluated by naked eye observation to determine the number of scratches observed. 0 scratches indicates ideal performance, while acceptable performance is generally indicated for surface having a small portion of visible observed scratches.

Transfer performance: Transfer performance was evaluated by naked eye observation.

The results were as follows:

TABLE I

| | | | | | | | Transfer |
|---|---|---|---|---|---|---|---|
| | L layer | H layer | HC | Adhesive | Reflectance % | Steel wool test | performance |
| Example 1 | L-1 | H-1 | HC-1 | Adh-1 | 0.8 | 0 scratches | Good |
| Example 2 | L-1 | H-1 | HC-1 | Adh-1 | No data | No data | Good |
| Example 3 | L-1 | H-3 | HC-1 | Adh-1 | 0.8 | 0 scratches | Good |
| Example 4 | L-1 | H-4 | HC-1 | Adh-1 | 0.8 | 2 scratches | Good |
| Example 5 | L-1 | H-1 | UVAD H-2 | UVAD H-2 | 0.7 | 8 scratches | Good |
| Example 6 | L-1 | H-1 | UVAD H-1 | UVAD H-1 | 0.8 | 20 scratches | Good |
| Comparison 1 | L-2 | H-1 | HC-1 | Adh-1 | No data | No data | Failed |
| Comparison 2 | L-4 | H-1 | HC-1 | Adh-1 | No data | No data | Failed |
| Comparison 3 | L-3 | H-1 | N/A | N/A | No data | No data | Poor coating |
| Comparison 4 | L-3 | H-1 | N/A | N/A | No data | No data | Poor coating |
| Comparison 5 | L-1 | H-2 | HC-1 | Adh-1 | 0.8 | >30 scratches | Good |
| Comparison 6 | None | None | None | None | 3.9 | Scratches all | N/A |
| | | | | | | over the surface | |

Table 1 illustrates how the low refractive index composition (L-1) for use in the transferable antireflection material showed good reflectance, scratch resistance and transfer performance as compared with other samples. Table 1 also illustrates the preferred factors for high refractive index composition to achieve good results. Table 1 thus shows that the preferred low refractive index and high index composition is available for use in a transferable antireflection coating.

While the invention has been described in terms of preferred embodiments, it will be understood, of course, that the invention is not limited thereto since modifications may be made by those skilled in the art, particularly in light of the foregoing teachings.

### Other Claims Applicant is Entitled

21. The method of claim 19, wherein forming a layer of said low refractive index material on said release layer comprises:
applying a wet layer of said low refractive index material to said release layer;
drying said wet layer to form a dry layer of said low refractive index material at a desired thickness on said release layer.

22. The method of claim 19, wherein forming a layer of said high refractive index material on said low refractive index material comprises:
applying a wet layer of said high refractive index material to said low refractive index material;
drying said wet layer to form a dry layer of said high refractive index material on said low refractive index material;
coupling a ultraviolet light source in close proximity to said release layer such that said release layer is located between said ultraviolet light source and said dry layer of said high refractive index layer; and
irradiating said dry layer with said ultraviolet light source at an intensity sufficient to cure said dry layer but insufficient to substantially increase the adhesion of said layer of said low refractive index material to said release layer.

23. The method of claim 22, wherein irradiating said dry layer comprises irradiating said dry layer with said ultraviolet light source at an wavelength more than about 300 nanometers to cure said dry layer.

24. The method of claim 19, wherein forming a layer of said UV curable adhesive hard coat material on said high refractive index material comprises:
applying a wet layer of said hard coat material to said high refractive index material;
drying said wet layer to form a dry layer of said UV curable hard coat material on said high refractive index material;
optionally coupling a ultraviolet light source in close proximity to said release layer such that said release layer is located between said ultraviolet light source and said dry layer of said UV curable adhesive hard coat material; and
irradiating said dry layer with said ultraviolet light source at an intensity sufficient to cure said dry layer but insufficient to substantially increase the adhesion of said layer of said low refractive index material to said release layer.

25. The method of claim 24, wherein optionally irradiating said dry layer comprises optionally irradiating said dry layer with said ultraviolet light source at an wavelength more than about 300 nanometers to cure said dry layer.

26. The method of claim 19, wherein providing a release layer comprises providing a PET film release layer.

27. An article having an optical display having decreased glare and improved durability and stain repellency, the optical display comprising:
(a) an optical substrate; and
(b) an antireflection material coupled to said optical substrate using a UV application technique, the transferable antireflection material comprising:
a removable release layer
a low refractive index layer coupled to said removable release layer, wherein the composition of said low refractive index layer comprises the reaction product of a fluoropolymer having at least one hexafluoropropylene monomer unit coupled to a vinylidene fluoride monomer unit; an amino silane coupling agent reacted with said one of said at least one vinylidene fluoride monomer unit; and an oligomer of a silicone alkoxy resin partially condensed with said amino silane coupling agent, wherein said oligomer of said silicone alkoxy resin comprises Si—(OR1)mR2n, wherein m is a whole number between 1 and 4 and n is a whole number between 0 and 3 such that m+n=4, and wherein R1 and R2 are alkyl groups;
a high refractive index layer coupled to said low refractive index layer; and
a UV curable adhesive hard coat layer coupled to said high refractive index layer.

28. The optical display of claim 27, wherein a portion of R1 in said oligomer of said silicone alkoxy resin is converted to an acetyl group.

29. The optical display of claim 27, wherein said high refractive index layer comprises a mixture of high index inorganic particles and a matrix resin.

30. The optical display of claim 29, wherein said high index inorganic particles is selected from the group consisting of zirconium dioxide particles and titanium dioxide particles.

31. The optical display of claim 29, wherein said matrix resin comprises a mixture of a multifunctional acrylate resin and a multifunctional epoxy acrylate resin.

32. The optical display of claim 31, wherein said multifunctional acrylate resin is selected from the group consisting of DPHA and PETA.

33. The optical display of claim 29, wherein said multifunctional epoxy acrylate resin is selected from the group consisting of a Bisphenol A epoxy acrylate resin and a novolac epoxy acrylate resin.

34. The optical display of claim 29, wherein said matrix resin comprises a silane coupling agent having an acryloyl group.

35. The optical display of claim 19, wherein said UV curable adhesive hard coat layer is selected from the group consisting of a UV curable multifunctional polyurethane acrylate resin, a UV curable multifunctional acrylic monomer resin, a UV curable difunctional polyurethane acrylate resin and a UV curable difunctional acrylic monomer resin.

36. An article having an optical display having decreased glare and improved durability and stain repellency, comprising:
(a) an optical substrate;
(b) a UV curable adhesive layer coupled to said optical substrate; and
(c) a transferable antireflection material coupled to said UV curable adhesive layer using a UV application technique, the transferable antireflection material comprising:
a removable release layer;
a low refractive index layer coupled to said removable release layer, wherein the composition of said low refractive index layer comprises the reaction product of a fluoropolymer having at least one hexafluoropropylene monomer unit coupled to a vinylidene fluoride monomer unit; an amino silane coupling agent reacted with said one of said at least one vinylidene fluoride monomer unit; and an oligomer of a silicone alkoxy resin partially condensed with said amino silane coupling agent, wherein said oligomer of said silicone alkoxy resin comprises Si—(OR1)mR2n, wherein m is a whole number between 1 and 4 and n is a whole number between 0 and 3 such that m+n=4, and wherein R1 and R2 are alkyl groups; and
a high refractive index layer coupled to said low refractive index layer.

37. The optical display of claim 36, wherein a portion of R1 in said oligomer of said silicone alkoxy resin is converted to an acetyl group.

38. The optical display of claim 36, wherein said high refractive index layer comprises a mixture of high index inorganic particles and a matrix resin.

39. The optical display of claim 38, wherein said high index inorganic particles is selected from the group consisting of zirconium dioxide particles and titanium dioxide particles.

40. The optical display of claim 38, wherein said matrix resin comprises a mixture of a multifunctional acrylate resin and a multifunctional epoxy acrylate resin.

41. The optical display of claim 40, wherein said multifunctional acrylate resin is selected from the group consisting of DPHA and PETA.

42. The optical display of claim 40, wherein said multifunctional epoxy acrylate resin is selected from the group consisting of a Bisphenol A epoxy acrylate resin and a novolac epoxy acrylate resin.

43. The optical display of claim 38, wherein said matrix resin comprises a silane coupling agent having an acryloyl group.

44. The optical display of claim 36, wherein said UV curable adhesive hard coat layer is selected from the group consisting of a UV curable multifunctional polyurethane acrylate resin, a UV curable multifunctional acrylic monomer resin, a UV curable difunctional polyurethane acrylate resin and a UV curable difunctional acrylic monomer resin.

45. A UV curable transferable antireflection material for use as an antireflective polymer film on an optical device, the transferable antireflection material comprising:
a removable release layer;
a low refractive index layer coupled to said removable release layer, wherein the composition of said low refractive index layer comprises the reaction product of a fluoropolymer having at least one hexafluoropropylene monomer unit coupled to a vinylidene fluoride monomer unit; an amino silane coupling agent reacted with said one of said at least one vinylidene fluoride monomer unit; and an oligomer of a silicone alkoxy resin partially condensed with said amino silane coupling agent, wherein said oligomer of said silicone alkoxy resin comprises Si—(OR1)mR2n, wherein m is a whole number between 1 and 4 and n is a whole number between 0 and 3 such that m+n=4, and wherein R1 and R2 are alkyl groups;
a high refractive index layer coupled to said low refractive index layer; and
a UV curable adhesive hard coat layer coupled to said high refractive index layer.

46. The transferable antireflection material of claim 45, wherein a portion of R1 in said oligomer of said silicone alkoxy resin is converted to an acetyl group.

47. The transferable antireflection material of claim 45, wherein said high refractive index layer comprises a mixture of inorganic particles and a matrix resin.

48. The transferable antireflection material of claim 47, wherein said inorganic particles is selected from the group consisting of zirconium dioxide particles and titanium dioxide particles.

49. The transferable antireflection material of claim 47, wherein said matrix resin comprises a mixture of a multifunctional acrylate resin and a multifunctional epoxy acrylate resin.

50. The transferable antireflection material of claim 49, wherein said multifunctional acrylate resin is selected from the group consisting of DPHA and PETA.

51. The transferable antireflection material of claim 49, wherein said multifunctional epoxy acrylate resin is selected from the group consisting of a Bisphenol A epoxy acrylate resin and a novolac epoxy acrylate resin.

52. The transferable antireflection material of claim 47, wherein said matrix resin comprises a silane coupling agent having an acryloyl group.

53. The transferable antireflection material of claim 45, wherein said UV curable adhesive hard coat layer is selected from the group consisting of a UV curable multifunctional polyurethane acrylate resin, a UV curable multifunctional acrylic monomer resin, a UV curable difunctional polyurethane acrylate resin and a UV curable difunctional acrylic monomer resin.

54. A UV curable transferable antireflection material for use on an optical substrate having a TV curable adhesive layer, the transferable antireflection material comprising:
a removable release layer;
a low refractive index layer coupled to said removable release layer, wherein the composition of said low refractive index layer comprises the reaction product of a fluoropolymer having at least one hexafluoropropylene monomer unit coupled to a vinylidene fluoride monomer unit; an amino silane coupling agent reacted with said one of said at least one vinylidene fluoride monomer unit; and an oligomer of a silicone alkoxy resin partially condensed with said amino silane coupling agent, wherein said oligomer of said silicone alkoxy resin comprises Si—(OR1)mR2n, wherein m is a whole number between 1 and 4 and n is a whole number between 0 and 3 such that m+n=4, and wherein R1 and R2 are alkyl groups; and
a high refractive index layer coupled to said low refractive index layer.

55. The transferable antireflection material of claim 54, wherein a portion of R1 in said oligomer of said silicone alkoxy resin is converted to an acetyl group.

56. The transferable antireflection material of claim 54, wherein said high refractive index layer comprises a mixture of inorganic particles and a index matrix resin.

57. The transferable antireflection material of claim 56, wherein said inorganic particles is selected from the group consisting of zirconium dioxide particles and titanium dioxide particles.

58. The transferable antireflection material of claim 56, wherein said matrix resin comprises a mixture of a multifunctional acrylate resin and a multifunctional epoxy acrylate resin.

59. The transferable antireflection material of claim 58, wherein said multifunctional acrylate resin is selected from the group consisting of DPHA and PETA.

60. The transferable antireflection material of claim 58, wherein said multifunctional epoxy acrylate resin is selected from the group consisting of a Bisphenol A epoxy acrylate resin and a novolac epoxy acrylate resin. 61. The transferable antireflection material of claim 56, wherein said matrix resin comprises a silane coupling agent having an acryloyl group.

What is claimed is:

1. A method for forming an optical display having decreased glare and improved durability and stain repellency, the method comprising:
(a) providing the optical display having an optical substrate;
(b) applying a layer of a UV curable hard coat layer to said optical substrate;
(c) forming a transferable antireflection material, the transferable antireflection material comprising:
(1) a release layer;
(2) a low refractive index layer coupled to said release layer, wherein the composition of said low refractive index layer comprises the reaction product of a fluoropolymer having at least one hexafluoropropylene monomer unit coupled to a vinylidene fluoride monomer unit; an amino silane coupling agent reacted with said one of said at least one vinylidene fluoride monomer unit; and an oligomer of a silicone alkoxy resin partially condensed with said amino silane coupling agent, wherein said oligomer of said silicone alkoxy resin comprises Si—(OR1)mR2n, wherein m is a whole number between 1 and 4 and n is a whole number between 0 and 3 such that m+n=4, and wherein R1 and R2 are alkyl groups; and
(3) a high refractive index layer coupled to said low refractive index layer;
(d) coupling said transferable antireflection material to said hard coat layer such that said high refractive index layer substantially abuts said hard coat layer;
(e) irradiating said transferable antireflection material and said UV curable adhesive layer to couple said high refractive index layer to said UV curable hard coat layer; and
(f) removing said release layer from said low refractive index layer.

2. The method of claim 1, wherein a portion of R1 in said oligomer of said silicone alkoxy resin is converted to an acetyl group.

3. The method of claim 1, wherein said high refractive index layer comprises a mixture of high index inorganic particles and a matrix resin.

4. The method of claim 3, wherein said high index inorganic particles is selected from the group consisting of zirconium dioxide particles and titanium dioxide particles.

5. The method of claim 3, wherein said matrix resin comprises a mixture of a multifunctional acrylate resin and a multifunctional epoxy acrylate resin.

6. The method of claim 5, wherein said multifunctional acrylate resin is selected from the group consisting of DPHA and PETA.

7. The method of claim 5, wherein said multifunctional epoxy acrylate resin is selected from the group consisting of a Bisphenol A epoxy acrylate resin and a novolac epoxy acrylate resin.

8. The method of claim 5, wherein said matrix resin comprises a silane coupling agent having an acryloyl group.

9. The method of claim 1, wherein said UV curable hard coat layer is selected from the group consisting of a UV curable multifunctional polyurethane acrylate resin, a UV curable multifunctional acrylic monomer resin, a UV curable difunctional polyurethane acrylate resin, and a UV curable difunctional acrylic monomer resin.

10. A method for forming an optical display having decreased glare and improved durability and stain repellency, the method comprising:
(a) providing the optical display having an optical substrate;
(b) forming a transferable antireflection material, the transferable antireflection material comprising:
(1) a release layer;
(2) a low refractive index layer coupled to said release layer, wherein the composition of said low refractive index layer comprises the reaction product of a fluoropolymer having at least one hexafluoropropylene monomer unit coupled to a vinylidene fluoride monomer unit; an amino silane coupling agent reacted with said one of said at least one vinylidene fluoride monomer unit; and an oligomer of a silicone alkoxy resin partially condensed with said amino silane coupling agent, wherein said oligomer of said silicone alkoxy resin comprises Si—(OR1)mR2n, wherein m is a whole number between 1 and 4 and n is a whole number between 0 and 3 such that m+n=4, and wherein R1 and R2 are alkyl groups;
(3) a high refractive index layer coupled to said low refractive index layer;
(4) a UV curable adhesive hard coat layer coupled to said high refractive index layer;
(c) coupling said transferable antireflection material to said optical substrate such that said UV curable adhesive hard coat layer substantially abuts said optical substrate;
(d) irradiating said transferable antireflection material to couple said UV curable adhesive hard coat layer to said optical substrate; and
(e) removing said release layer from said low refractive index layer.

11. The method of claim 10, wherein a portion of R1 in said oligomer of said silicone alkoxy resin is converted to an acetyl group.

12. The method of claim 10, wherein said high refractive index layer comprises a mixture of high index inorganic particles and a matrix resin.

13. The method of claim 12, wherein said high index inorganic particles is selected from the group consisting of zirconium dioxide particles and titanium dioxide particles.

14. The method of claim 12, wherein said matrix resin comprises a mixture of a multifunctional acrylate resin and a multifunctional epoxy acrylate resin.

15. The method of claim 14, wherein said multifunctional acrylate resin is selected from the group consisting of DPHA and PETA.

16. The method of claim 14, wherein said multifunctional epoxy acrylate resin is selected from the group consisting of a Bisphenol A epoxy acrylate resin and a novolac epoxy acrylate resin.

17. The method of claim 12, wherein said matrix resin comprises silane coupling agent having an acryloyl group.

18. The method of claim 10, wherein said UV curable hard coat layer is selected from the group consisting of a UV curable multifunctional polyurethane acrylate resin, a UV curable multifunctional acrylic monomer resin, a UV curable difunctional polyurethane acrylate resin and a UV curable difunctional acrylic monomer resin.

19. A method for forming a heat transferable antireflection material for use as a protective and optically desirable layer on an optical display of an article, the method comprising:
providing a release layer;
forming a low refractive index material, wherein the composition of said low refractive index material comprises the reaction product of a fluoropolymer having at least one hexafluoropropylene monomer unit coupled to a vinylidene fluoride monomer unit; an amino silane coupling agent reacted with said one of said at least one vinylidene fluoride monomer unit; and an oligomer of a silicone alkoxy resin partially condensed with said amino silane coupling agent, wherein said oligomer of said silicone alkoxy resin comprises Si—(OR1)mR2n, wherein m is a whole number between 1 and 4 and n is a whole number between 0 and 3 such that m+n=4, and wherein R1 and R2 are alkyl groups;
forming a layer of said low refractive index material on said release layer;
forming a high refractive index material;
forming a layer of said high refractive index on said low refractive index material;
forming a UV curable adhesive hard coat material; and
forming a layer of said UV curable adhesive hard coat material on said high refractive index material.

20. The method of claim 19, wherein a portion of R1 in said oligomer of said silicone alkoxy resin is converted to an acetyl group.
